(19) United States
(12) Patent Application Publication
(10) Pub. No.: US 2015/0324691 A1
(43) Pub. Date: Nov. 12, 2015

(54) NEURAL NETWORK CONNECTIONS USING NONVOLATILE MEMORY DEVICES

(71) Applicant: Seagate Technology LLC, Cupertino, CA (US)

(72) Inventors: Frank Dropps, Maple Grove, MN (US); Antoine Khoueir, Edina, MN (US); Kevin Arthur Gomez, Eden Prairie, MN (US); Jon Trantham, Chanhassen, MN (US)

(21) Appl. No.: 14/704,124

(22) Filed: May 5, 2015

Related U.S. Application Data
(60) Provisional application No. 61/989,812, filed on May 7, 2014.

(51) Int. Cl. G06N 3/08; G06N 3/04

(52) U.S. Cl. CPC G06N 3/08; G06N 3/04

(57) ABSTRACT

A system includes a plurality of nonvolatile memory cells and a map that assigns connections between nodes of a neural network to the memory cells. Memory devices containing nonvolatile memory cells and applicable circuitry for reading and writing may operate with the map. Information stored in the memory cells can represent weights of the connections. One or more neural processors can be present and configured to implement the neural network.

### CROSS REFERENCE TO RELATED APPLICATIONS

This application claims priority and benefit to U.S. Provisional Patent Application No. 61/989,812, entitled “NEURAL NETWORK CONNECTIONS USING NONVOLATILE MEMORY DEVICES”, filed on May 7, 2014. The content of that application is incorporated herein in its entirety by reference.

### SUMMARY

Some embodiments are directed to a system that includes a plurality of nonvolatile memory cells. A map assigns connections between nodes of a neural network to the memory cells.

According to some embodiments, a system comprises a memory device that includes a plurality of nonvolatile memory cells and read/write circuitry configured to read information from and write information to the memory cells. A map that assigns connections between nodes of a neural network to memory cells of the memory device. The information stored in the memory cells corresponds to weights of the connections. A memory controller is configured to control read and write operations of the memory cells. One or more neural processors implement the neural network.

Some embodiments involve a method of implementing a neural network. The method includes mapping connections between nodes of a neural network to memory cells of a nonvolatile memory device. Information representing the connection weights is stored information in the memory cells. The information is read from the memory cells and is used in operating the neural network.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 is a block diagram that conceptually illustrates embodiments discussed herein;

FIG. 2A depicts a simple neural network having a plurality of nodes and connections between the nodes;

FIG. 2B depicts a table illustrating mapping connections of the neural network of FIG. 2A to memory cells according to embodiments discussed herein;

FIG. 3 illustrates an array of nonvolatile floating gate memory cells arranged in a NAND flash memory device;

FIG. 4 illustrates a block diagram of a system in accordance with embodiments disclosed herein; and

FIG. 5 is a flow diagram that illustrates processes according to embodiments discussed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Artificial Neural Networks (ANNs) are information processing systems that in some ways mimic the way biological nervous systems such as the human brain processes information. According to some implementations, an ANN comprises a large number of interconnected nodes which are processing elements. The nodes work in conjunction to solve specific problems. For example, ANNs can be trained and can learn through trial and error by modifying the connections between nodes and/or adjusting the weighting of the connections between nodes.

Embodiments described herein use a multilevel nonvolatile memory device to store the connection weights for a neural network. Multilevel memory cells are capable of storing an analog value representing the connection weight. One example of such a memory device is commercially available NAND flash memory, which is used for several examples discussed below, although other types of multilevel nonvolatile memory devices may alternatively be used, e.g., phase change memory, resistive RAM, NOR Flash, magnetic RAM spin-torque RAM, etc. The nonvolatile memory can be used to store connection weights and optionally store the mapping between nodes for the neural network. Because the nonvolatile memory cells are capable of storing an analog value it is possible for only one memory cell to store the weight for a connection. Furthermore, the nonvolatile memory device provides persistent storage for the connection weight and/or other neural network information. The network may be powered down at any time without losing the mapping and/or connection weights and thus relearning is not needed. In some embodiments, the mapping may be static. In other embodiments, the mapping may be dynamically changed by the neural network. For example, dynamic modification of the mapping can involve eliminating some connections and/or adding other connections. The connections weights may be changed by adding or subtracting charge if the memory is a flash type or increasing or decreasing resistance if it is a resistive type memory.

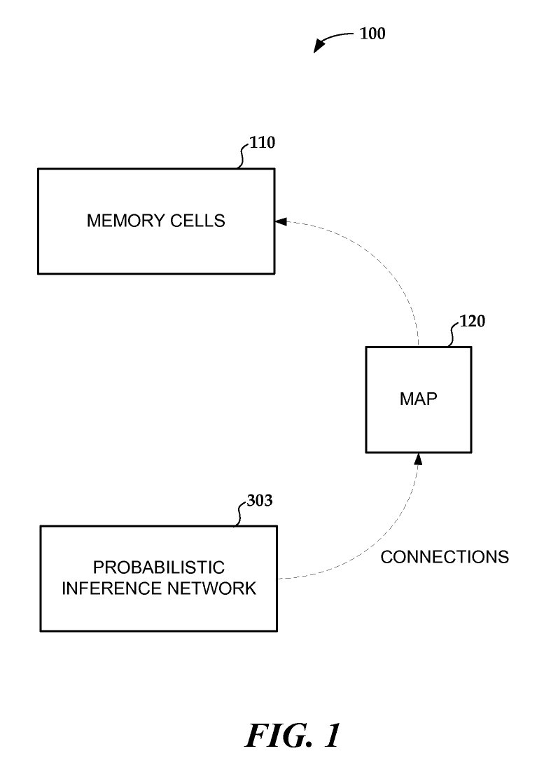

FIG. 1 is a block diagram that conceptually illustrates embodiments discussed herein. The block diagram depicts system 100 that includes a plurality of nonvolatile memory cells 110. The memory cells 110 may be arranged as an addressable array of a memory device, such floating gate transistor memory cells arranged in an array of a NAND or NOR flash memory device. The memory cells may arranged in the memory device so that random access is limited, meaning that reading information from and writing information to the memory cells memory device occurs in multi-cell units. Alternatively, the memory cells may be arranged in some types of nonvolatile memory so that each memory cell can be individually randomly accessed. A map 120, which may be stored in the memory device 110 or elsewhere, includes connection assignments between nodes of a neural network 130 and memory cells of the memory device 110.

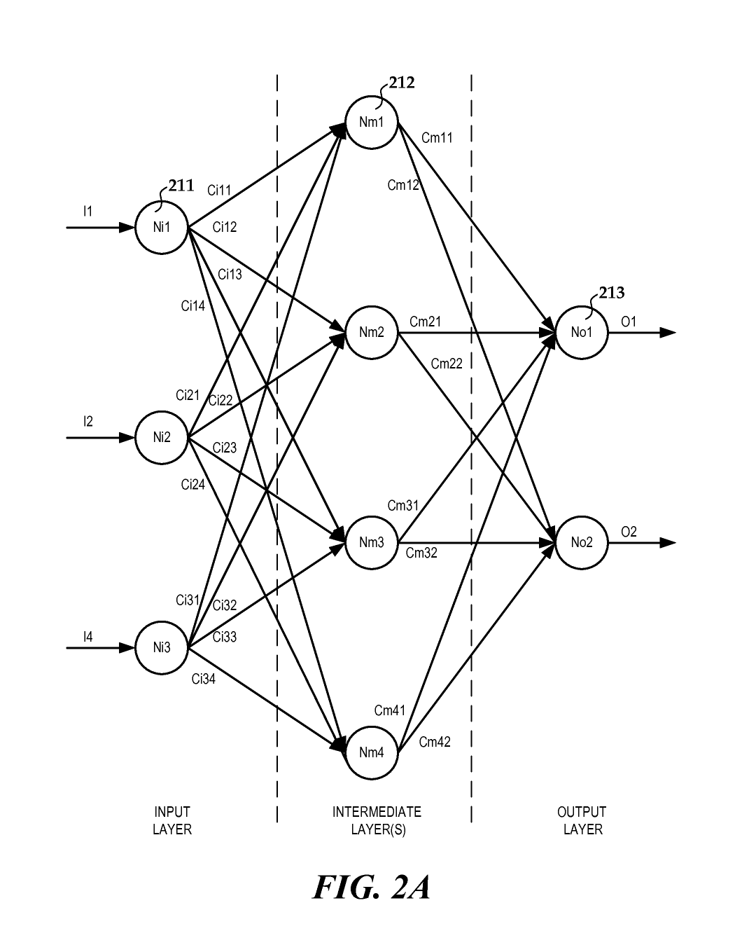

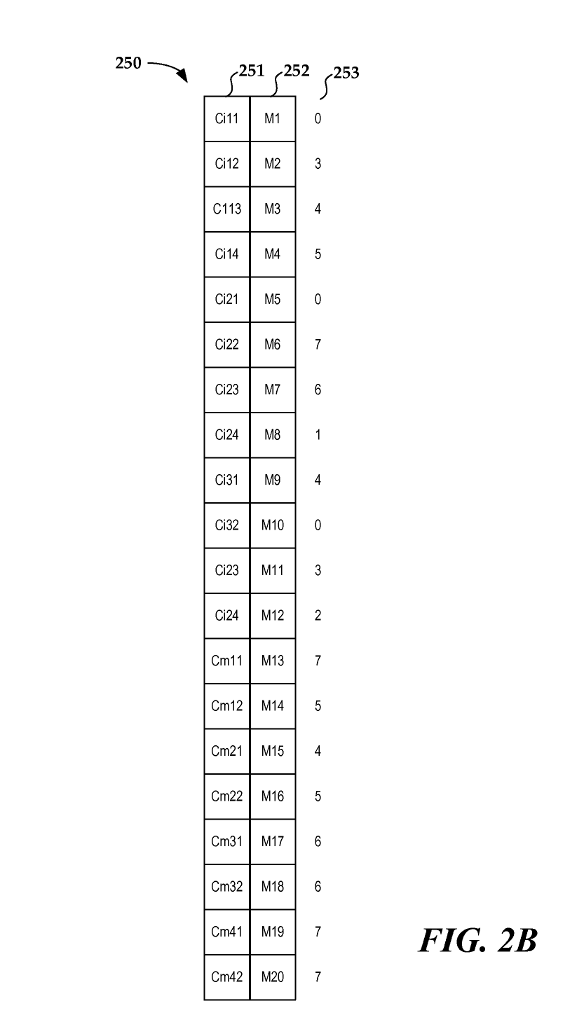

FIG. 2A depicts a simple neural network 200 having a plurality of nodes 211, 212, 213 (electronic neurons) arranged in an input layer 201, an intermediate layer 202, and an output layer 203. Inputs I1, I2, I3 are connected to the input nodes Ni1, Ni2, Ni3 and outputs O1, O2 are provided by output nodes No1, No2. Neural networks in general may be much more complex than the neural network 200 depicted in FIG. 2 and may have additional intermediate layers.

In the illustrated diagram each node is connected to the nodes in adjacent layers. For example, node Ni1 is connected to node Nm1 through connection Ci11 and is connected to node Nm2 through connection Ci12, etc. In some configurations it is possible that some nodes are not connected to each of the nodes in adjacent layers. For example, if a neural network included first and second intermediate layers, one or more of the nodes of the first intermediate layer may not be connected to each of the nodes of the second intermediate layer.

Each node is associated with a transfer function that operates on the node inputs to produce the node outputs. The node inputs are provided by the connections to other nodes or the network inputs I1, I2, I3. Each of the connections between nodes is associated with a weight which determines that connections importance in determination of the output. Neural networks can learn to provide a target output to a known input by iteratively computing a output and then adjusting the weights of the connections between nodes to get closer and closer to the target output. The processing to implement the transfer function may be implemented by distributed processor for each (or a group) of nodes, or by a central processor that implements the processing for each node.

Embodiments disclosed herein are directed to the use of nonvolatile memory cells, such as the nonvolatile memory cells in a commercially available flash memory device, to store the weights of the connections for a neural network. A map, which may be implemented as a table stored elsewhere in the nonvolatile memory device, maps the connections to the memory cells and provides the weights of the connections. When multilevel memory cells are used the mapping between connections and memory cells can be one-to-one. FIG. 2B depicts a table 250 illustrating mapping connections of neural network 200 to memory cells. The first column 251 in table 250 lists the connections of the neural network 200 and the second column 252 lists the memory cells that correspond to the connections.

Shown in FIG. 2B beside the memory cells are the connection weights 253. These weights are not part of the table 250, but represent information that is stored in the corresponding memory cells. In this particular example, the memory cells are capable of storing three bits (8 analog levels) of information, where level 0 is represents no or minimal connection weight between nodes and level 7 represents the highest weight.

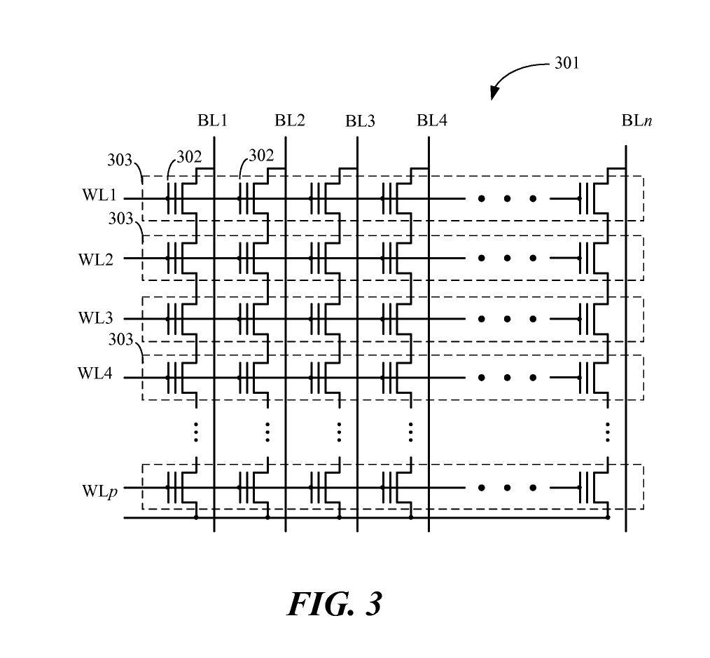

FIG. 3 illustrates an array 301 of nonvolatile floating gate memory cells 302 arranged in a NAND flash memory device. Floating gate memory cells can be formed of metal oxide semiconductor field effect transistors (MOSFET), with two gates. One of the gates is a control gate for the MOSFET and another gate, referred to as a floating gate, is formed between the control gate and the MOSFET channel. The floating gate is insulated by an oxide layer. Charge can be trapped at the floating gate, and, under normal conditions, will not discharge for many years. When the floating gate holds a charge, it affects the electric field from the control gate, which modifies the threshold voltage threshold voltage of the memory cell. Reading a multi-level flash memory cell involves applying comparing the threshold voltage of the memory cell to multiple reference voltages, i.e., one reference voltage for each bit of data stored.

In general, a memory cell may be programmed to a number of voltages, M, where M can represent any of 2^{m} memory states. The value m is equal to the number of bits stored. For example, memory cells programmable to four voltages can store two bits per cell (M=4, m=2); memory cells programmable to eight voltages have a storage capacity of three bits per cell (M=8, m=3), etc.

In a flash memory device, the memory cells may be grouped into data units referred to herein as data words, data pages, or data blocks. In the illustrated example, a data page corresponds to a group of memory cells that are read together during a read operation. A unit of memory cells, i.e., a group of multiple pages, that are erased at substantially the same time may be referred to as a block or erasure unit. Garbage collection operations can be performed on the blocks of pages, wherein the blocks are erased after active data stored in each block is moved to another location.

An exemplary block size includes 64 pages of memory cells with 16,384 (16K) memory cells per physical page. Other block or page sizes can be used. FIG. 3 illustrates one block of a memory cell array 301. The memory cell array 301 comprises p×n memory cells per block, the memory cells (floating gate transistors or charge trap) 302 arranged p rows of pages 303 and in columns of n NAND strings. Each page 303 is associated with a word line WL1-WLp. When a particular word line is energized, the n memory cells of the page 303 associated with that particular word line are accessible on bit lines BL1-BLn. It will be understood that the approaches discussed herein are applicable to other arrangements of nonvolatile memory cells, e.g., NOR arrays as well as to other types of multilevel nonvolatile memory cells.

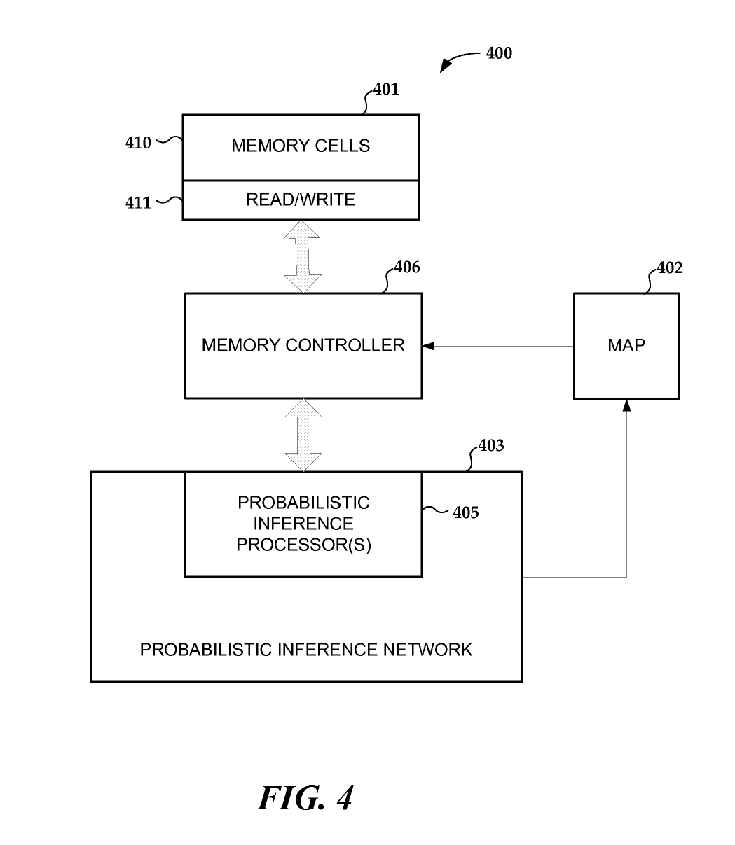

FIG. 4 illustrates a block diagram of a system in accordance with embodiments disclosed herein including a memory device 401 comprising an array of memory cells 410.

The system includes a map 402 that maps connections of a neural network 403 to the memory cells 410. The node functions of the neural network 403 are implemented by at least one neural processor 405. A memory controller 406 and read/write circuitry in the memory device 401 provide an interface between the neural processor 405 and the memory cell array 401. The memory controller 406 controls reading from and writing to the memory cells 401.

The read/write circuitry 411 of the memory device 401 receives commands from the controller 406 and generates the electrical signals to implement reading from and writing to the memory cells 410. Additionally, the memory controller 406 may encode, decode and apply error detection and/or correction to the information (connection weights) passed between the neural processor 405 and the memory cells 401. The controller 406 may further provide functionality such as wear leveling and/or garbage collection for the memory cell array 401.

As the neural network 403 learns, the weights of the connections are adjusted. The neural network 403 sends a digital representation of the connection weight values to the controller 406 with a request to update the connection weights. The controller 406 accesses the map 402 to determine the memory cells that correspond to the connections that have changed weights. The controller 406 than commands the write circuitry 411 to make adjustments to the information stored in those memory cells. As the neural network operates, it may access the memory cells 410 to obtain the weights of the connections. For example, the neural network 403 may send a request to the controller 406 to retrieve the weights for certain connections from the memory cells. The controller accesses the map 402 to determine which memory cells correspond to the connections requested by the neural network 403, reads the information from those memory cells, and provides the information in digital form to the neural network 403.

Using a floating gate or charge trap flash memory as an example, to implement write operations, read/write circuitry 411 of the memory device 401 receives from the memory controller 406 a digital representation of the information that needs to be stored into the memory cells, the information corresponding to weights for one or more connections of the neural network. The write circuitry 411 generates pulses that adjusts the amount of charge stored in the memory cell corresponding to the weight for that connection.

To implement a read operation, the read circuitry 411 places a read voltage on the control gate of the memory cell and senses the current from the memory cell. The voltage corresponding to the sensed current is compared to reference voltages, V_{R}s, to determine the threshold voltage of the cell. As previously discussed, the threshold voltage of the cell is a function of the stored charge. The read circuitry 411 passes a digital representation of information stored in the memory cell to the controller 406.

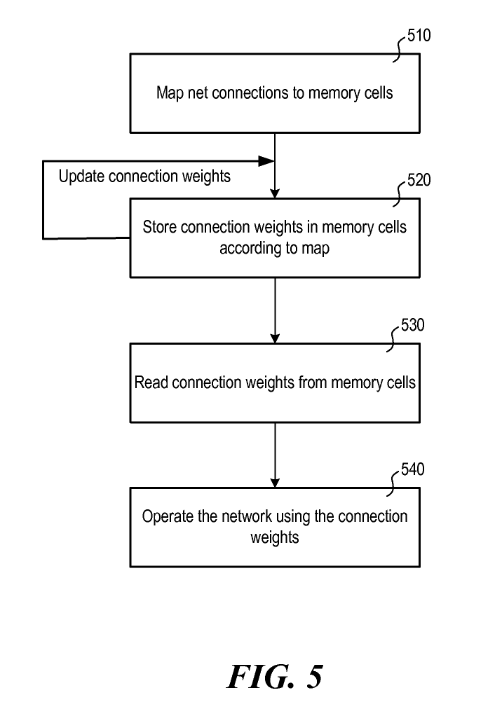

FIG. 5 is a flow diagram that illustrates processes according to embodiments discussed herein. The process includes mapping 510 nonvolatile memory cells to connections of a neural network. Connection weights are stored 520 in the memory cells according to the map. As the neural network learns, the weights may be updated. The updating process may involve accessing the map to determine the memory cells that are mapped to connections and updating the information stored in the memory cells. As the neural network operates, the memory cells are read 530 to retrieve the connection weights stored therein. Reading the connection weights may involve accessing the map to determine the memory cells that are mapped to connections and reading the appropriate memory cells. The neural network is implemented 540 using the connection weights retrieved from the memory cells.

In various embodiment, all or part of the neural network and/or memory controller may be implemented in hardware. In other exemplary embodiments, the neural network and/or memory controller may be implemented in firmware, software running on a microcontroller or other device, or any combination of hardware, software and firmware.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A system, comprising:
a plurality of nonvolatile memory cells; and
a map that assigns connections between nodes of a neural network to the memory cells.

2. The system of claim 1, wherein the memory cells are selected from the group consisting of floating gate memory cells and charge trap memory cells, and are arranged in a memory cell array of a flash memory device.

3. The system of claim 1, further comprising read/write circuitry configured to read information from and store information to the memory cells.

4. The system of claim 3, wherein during a read operation, the read/write circuitry is configured to:
sense a voltage indicating an amount of charge stored on each memory cell, the amount of charge representing a weight of the connection; and
compare the voltage to a threshold to determine the amount of charge.

5. The system of claim 3, wherein during a write operation, the read/write circuitry is configured to apply voltage pulses that store an amount of charge on each memory cell, the amount of charge representing a weight of the connection.

6. The system of claim 1, wherein each memory cell stores charge corresponding to 2ⁿ voltage levels.

7. The system of claim 6, wherein n is greater than 2.

8. The system of claim 1, further comprising one or more neural processors configured to implement the neural network.

9. The system of claim 8, wherein the neural processors are configured to assign a weight to each connection of the neural network.

10. The system of claim 8, wherein the neural processors are configured to dynamically update the connectivity of the neural network and to dynamically update the map to reflect the updated connectivity.

11. The system of claim 1, wherein the map is static.

12. A system, comprising:
a memory device comprising:
a plurality of nonvolatile memory cells;
circuitry configured to read information from and write information to the memory cells;
a map that assigns connections between nodes of a neural network to memory cells of the memory device, the information stored in the memory cells representing weights of the connections;
a controller configured to control read and write operations of the memory cells; and
one or more neural processors configured to implement the neural network.

13. The system of claim 12, wherein the neural processors are configured to dynamically update the connections of the map.

14. The system of claim 12, wherein:
the neural network dynamically updates the weights of the connections; and
the controller causes the updated weights to be stored in the memory cells based on the map.

15. The system of claim 12, wherein the controller causes the information to be read from the memory cells as requested by the neural processors.

16. The system of claim 12, wherein the memory device is one of NAND flash, NOR flash, resistive random access memory (ReRAM), magnetoresistive random access memory (MRAM), phase change random access memory (PCRAM) or spin-torque random access memory (STRAM).

17. A method, comprising:
mapping connections between nodes of a neural network to nonvolatile memory cells of a memory device;
storing information in the memory cells that represents the connection weights;
reading the information from the memory cells; and
operating the neural network using the information.

18. The method of claim 17, wherein the mapping step is a one-to-one mapping.

19. The method of claim 17, further comprising dynamically updating the connection weights.

20. The method of claim 17, wherein operating the neural network comprises:
reading the information stored in the memory cells; and
using the information to implement the neural network.
